(19) United States
(12) Patent Application Publication
(10) Pub. No.: US 2015/0251746 A1
(43) Pub. Date: Sep. 10, 2015

(54) WINDOW FOR AN AIRCRAFT

(71) Applicant: DIEHL AEROSPACE GMBH, Ueberlingen (DE)

(72) Inventors: Frank SCHMID, Poppenricht (DE); Martin BACHHUBER, Altdorf (DE)

(73) Assignee: DIEHL AEROSPACE GMBH, Ueberlingen (DE)

(21) Appl. No.: 14/640,515

(22) Filed: Mar. 6, 2015

(30) Foreign Application Priority Data
Mar. 6, 2014 (DE) 102014003365.1

(51) Int. Cl. B64C 1/14; G02F 1/163; G02F 1/157

(52) U.S. Cl. CPC B64C 1/1492; G02F 1/157; G02F 1/163

(57) ABSTRACT

The invention relates to a window for an aircraft with a pressurised cabin, in which in a frame (1) is fixed an outer pane (3) facing away from a cabin interior (I) when installed and an inner pane (4) facing the cabin interior (I), so that an intermediate space (Z) is formed between the outer (3) and the inner pane (4). To create a lighting function, in accordance with the invention it is proposed that at least one of the inner (4) and the outer panes (3) is provided with a layer (5) of organic light-emitting diodes. In addition, one of the inner (4) and the outer panes (3) is provided with an electrochromic second layer (6).

### BACKGROUND OF THE INVENTION

The invention relates to a window for an aircraft in accordance with the preamble of claim 1 and an aircraft with such a window.

### DISCUSSION OF THE PRIOR ART

Such a window, for example, is known from EP 0 846 616 B 1.

DE 10 2006 005 523 A1 discloses a window installation unit for an aircraft with shading and lighting function. To achieve the shading function it is proposed to coat the window pane with an electrochromic layer. The lighting function is realised by several lighting means which are arranged on a window funnel surrounding the window. The arrangement of the lighting means on the window funnel and the production of an electrical connection between each lighting means and a control unit requires highly extensive installation.

### SUMMARY OF THE INVENTION

The task of the invention is to remedy the disadvantages from the state of the art. In particular, a window for an aircraft and a lighting arrangement which can be installed quickly and easily are specified. In accordance with a further objective of the invention, a window that is simple to install is to be specified.

As stipulated in the invention it is proposed that at least one of the inner and outer panes is provided with a transparent first layer made of organic light-emitting diodes. By using a first layer formed of organic light-emitting diodes, which layer is attached to at least one of the panes, as the lighting means in accordance with the invention, the extensive installation of additional lighting means, for example on a window funnel surrounding the window, can be dispensed with. Furthermore, the extensiveness of producing an electrical connection between each of the lighting means and a control unit can be dispensed with. The window in accordance with the invention can be installed quickly and simply. Thus, an effective and aesthetically responsive illumination in the cabin interior can be achieved.

At least one of the inner and outer panes is provided with an electrochromic second layer. An “electrochromic layer” concerns a crystalline layer that changes its light transmission depending on a voltage applied to it. Such an electrochromic layer may, for example, be formed from an SPD (suspended particle device) film.

In an advantageous embodiment, the first layer is arranged on an inside of the inner pane facing away from the outer pane. That enables a particularly efficient illumination of the cabin interior. The second layer can be arranged on an outer side of the inner pane facing the outer pane. By attaching both the first and the second layer onto the inner pane, the extensiveness of producing an electrical connection with a control system is reduced, for example a control unit or a cabin control system.

It may also be that the first and second layer are arranged mutually overlapping on the inner side of the inner pane. In this case, the second layer is advantageously arranged directly on the inner side of the inner pane.

The reflectivity of the second layer is in a shaded state is greater than when not in a shaded state. When switching the second layer to the shaded state while activating the first layer, with particularly high effectiveness, light from the first layer can be disconnected and be used to light the cabin interior. The reflective effect of the second layer situated in a shaded state is greater, the nearer you are to the first layer.

As further stipulated in the invention an aircraft with a window in accordance with the invention is proposed, in which the control system is arranged for individual controlling of the first and/or second layer in the vicinity of the window, preferably on a window funnel facing the cabin interior. The control system may, for example, be respectively embodied by a foil switch to switch the first and second layer on and off. The arrangement of the control system in the area of the window funnel further simplifies the extensiveness of the installation. Only electrical connections short in length to the first and as necessary to the second layer are required.

In a further embodiment, the first and, as necessary, the second layer is connected by control technology to a central cabin control system. Therefore, it is possible to control the first and, as necessary, the second layer automatically depending on the quantities measured with sensors, for example, a light irradiation onto the aircraft, and/or depending on the specified computer program.

### BRIEF DESCRIPTION OF THE DRAWINGS

In the following, examples of the invention will be explained in more detail using the drawings.

FIG. 1 shows a schematic partial cross-section through a first window,

FIG. 2 shows a schematic partial cross-section through a second window,

FIG. 3 shows a schematic partial cross-section through a third window and

FIG. 4 shows a schematic partial cross-section through a fourth window.

### DETAILED DESCRIPTION OF THE INVENTION

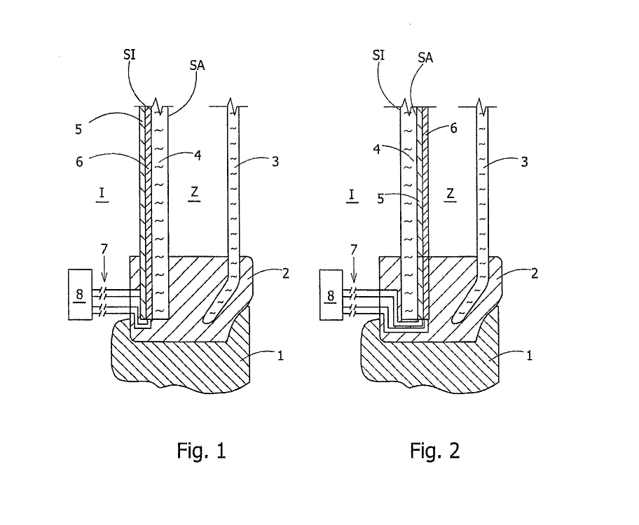

FIG. 1 to FIG. 4 show respectively schematic partial cross-sections of a window or a window installation unit for an aircraft. For example, with reference number 1 a frame made of aluminium is designated, in which a sealing profile 2 is fixed. A surrounding edge of an outer pane 3 and a further surrounding edge of an inner pane 4 are respectively fixed in the sealing profile 2. Between the outer pane 3 and the inner pane 4 an intermediate space Z is formed. The inner pane 4 faces a cabin interior I when installed. The outer 3 and inner pane 4 may be made of polycarbonate, for example.

In the first window shown in FIG. 1, on an inner side SI of the inner pane 4 facing the cabin interior I a first layer 5 is provided, which contains organic light-emitting diodes. Between the first layer 5 and the inner side SI, an electrochromic second layer 6 is closed. The supply lines for the optional supply of the first 5 and second layer 6 with electricity are designated with the reference number 7. They are connected to a control system 8. The control system 8 may be a manual control unit or a central cabin control system. It is also possible to provide both a manual control unit and to connect the supply lines 7 for the purposes of control to the central cabin control system.

In the second window shown in FIG. 2, the first layer 5 is attached to the outer side SA of the inner pane 4. The first layer 5 is overlaid by the second layer 6.

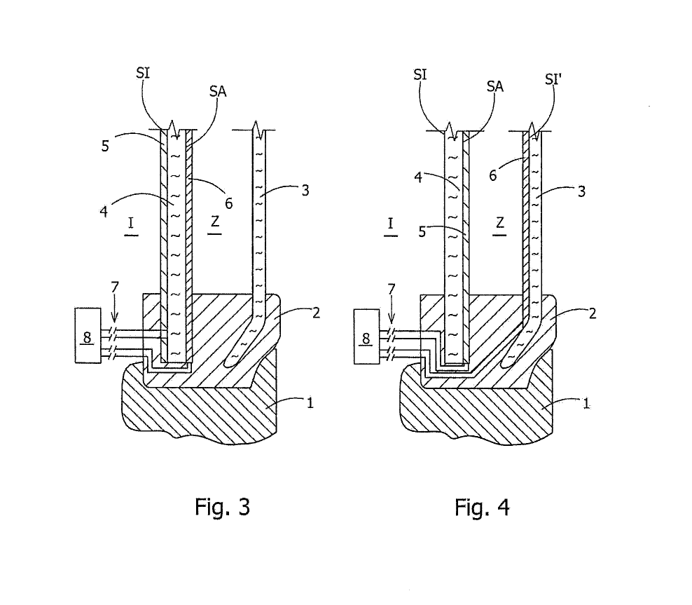

In the third window shown in FIG. 3, the first layer 5 is attached to the inner side SI of the inner pane 4 and the second layer 6 is attached to the outer side SA of the inner pane 4.

FIG. 4 shows a partial cross-sectional view through a fourth window. In the fourth window the first layer 5 is arranged on the outside SA of the inner pane 4. The second layer 6 is arranged on a further inner side SI′ of the outer pane 3 facing the intermediate space Z.

The function of the window shown in FIG. 1 to FIG. 4 is the following:

By means of the first layer 5, the cabin interior I can optionally be illuminated. With the second layer 6 which, for example, may concern an SPD film, the window may be shaded.

To achieve the most efficient possible lighting of the cabin interior I by means of the first layer 5 it is advantageous to arrange a sequence of the first 5 and the second layer 6 always so that the first layer 5 is seen from the cabin interior I and the second layer 6 is always arranged in front.

To improve the efficiency of the lighting effect of the first layer 5 further, it is advantageous, when activating the organic light-emitting diodes in the first layer 5 while replacing the second layer 6 from a transparent operating method to a shading operation method. In this case, light generated from the first layer 5 is reflected from the second layer 6 and directed in the direction of the cabin interior I, so that an improved lighting effect is achieved with the first layer. For this reason, the control system 8 may be designed advantageously so that when activating the organic light-emitting diodes in the first layer 5, the second layer 6 is automatically set into the shading operating method.

### REFERENCE LIST

1 Frame
2 Sealing profile
3 Outer pane
4 Inner pane
5 First layer
6 Second layer
7 Supply line
8 Control system
I Cabin interior
Z Intermediate space
SI Inner side
SA Outer side
SI′ Further inner side

What is claimed is:

1. A window for an aircraft for a pressurised cabin, wherein in a frame an outer pane facing away from a cabin interior (I) when installed and an inner pane facing the cabin interior (I) are fixed, so that an intermediate space (Z) is formed between the outer and the inner pane,
wherein
at least one of the inner and the outer panes is provided with a transparent first layer of organic light-emitting diodes and
wherein at least one of the inner and the outer panes is provided with an electrochromic second layer.

2. The window according to claim 1, wherein the second layer is formed from an SPD film.

3. The window according to claim 1, wherein the first layer is arranged on an inner side (SI) of the inner pane facing away from the outer pane.

4. The window according to claim 1, wherein the second layer is arranged on an outer side (SA) of the inner pane facing the outer pane.

5. The window in according to claim 1, wherein the first and second layer are arranged mutually overlapping on the inner side (SI) of the inner pane.

6. An aircraft with a window according to claim 1.

7. The aircraft according to claim 6, wherein a control system for individual control of the first and as necessary the second layer is arranged in the vicinity of the window.

8. The aircraft according to claim 7, wherein said control system is arranged on a window funnel facing the cabin interior (I).

9. The aircraft according to claim 6, wherein the first and, as necessary, the second layer is connected by control technology to a control system designed as a central cabin control system.
